(19) United States
(12) Patent Application Publication
(10) Pub. No.: US 2014/0316848 A1
(43) Pub. Date: Oct. 23, 2014

(54) Cross-Channel Analytics Combining Consumer Activity on the Web and in Physical Venues

(71) Applicant: INTERNATIONAL BUSINESS MACHINES CORPORATION, Armonk, NY (US)

(72) Inventors: Omri Fuchs, Ramat Gan (IL); Sima Nadler, Kochav Yair (IL)

(73) Assignee: International Business Machines Corporation, Armonk, NY (US)

(21) Appl. No.: 13/867,081

(22) Filed: Apr. 21, 2013

(51) Int. Cl. G06Q 30/02

(52) U.S. Cl. CPC G06Q 30/02
USPC 705/7.29

(57) ABSTRACT

Machines, systems, products and methods for cross-referencing a consumer's shopping activities in a physical venue to the consumer's online activities, the method comprising: uniquely identifying a consumer based on a unique ID associated with the consumer's mobile communication device; monitoring speed and location of the consumer in one or more zones in a physical venue by detecting and processing communication signals broadcasted by the consumer's mobile communication device; determining level of interest of the consumer in one or more products positioned in the one or more zones in the physical venue based on speed with which the consumer moves through the one or more zones; and equating a first level of interest in a first product in the physical venue to a page view on a webpage that promotes the first product or group of products.

### CROSS-REFERENCE TO RELATED APPLICATIONS

The present application is related to U.S. application Ser. No. ______, filed on ______, Attorney Docket No. IL920120105US1 and U.S. application Ser. No. ______, filed on ______, Attorney Docket No. IL920120106US1. The content of both of the above-noted applications is incorporated herein by reference in entirety.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to consumer analytics and, more particularly, to systems and methods for tracking consumer activity of a unique individual both on the web and in physical retail s.

### BACKGROUND

Consumers use multiple retail channels such as websites, call centers, mobile applications and physical retail stores to research and purchase consumer goods and services. Advertisers and retailers are interested in understanding consumer behavior across these different channels because a better understanding provides for better consumer profiling and cross-channel advertising and pricing. Consumer profiling is typically accomplished by gathering statistical data and demographics about an individual consumer or a crowd of consumers.

Some consumer profiling schemes are directed to profiling on-line consumer behavior (i.e., web browsing activities). Some solutions have also been introduced to track consumer behavior in physical venues such as retail stores. No process or mechanism exist, however, that can be used to correlate on-line and in-store activities of a consumer in order to generate meaningful results that can be used to better understand the respective relationships between a unique consumer's activities in virtual (i.e., on-line) and physical (i.e., in-store) venues.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, machines, systems, products and methods for cross-referencing a consumer's shopping activities in a physical venue to the consumer's online activities are provided. The method comprises uniquely identifying a consumer based on a unique ID associated with the consumer's mobile communication device; monitoring speed and location of the consumer in one or more zones in a physical venue by detecting and processing communication signals broadcasted by the consumer's mobile communication device; determining level of interest of the consumer in one or more products positioned in the one or more zones in the physical venue based on speed with which the consumer moves through the one or more zones; and equating a first level of interest in a first product in the physical venue to a page view on a webpage that promotes the first product or group of products.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary operating environment in accordance with one or more embodiments, wherein consumer activity may be tracked while browsing on-line or in a physical store.

FIG. 2 is a flow chart of a method of identifying a consumer based on a unique ID associated with a mobile communication device, in accordance with one embodiment.

FIG. 3 is a flow chart of a method of determining a consumer's level of interest in one or more products in a store, in accordance with one embodiment.

FIGS. 4A and 4B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

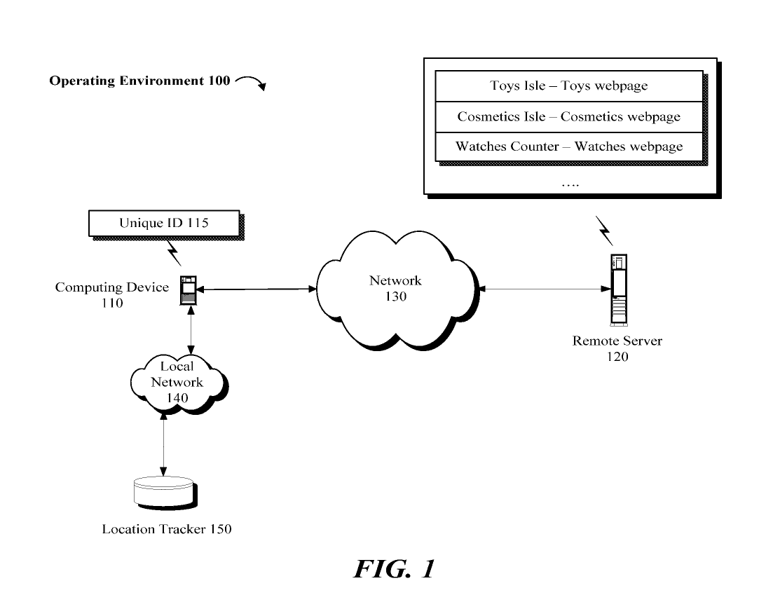

Referring to FIG. 1, an exemplary operating environment 100 is illustrated in which a computing device 110 (e.g., a smart phone, a tablet, a computer, etc.) is used by a consumer to browse digital content related to consumer goods or services, for example. Computing device 110 may connect and communicate with one or more remote servers 120 over a network 130 (e.g., the Internet) to access the desired content. Computing device 110 is preferably or optionally a portable device that a consumer may carry to a physical retail location where goods may be physically purchased over the counter.

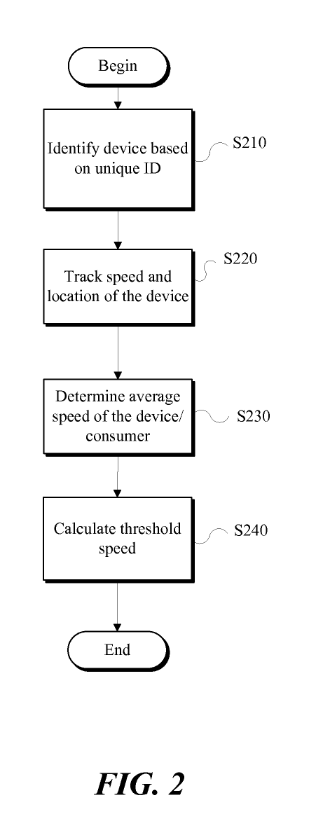

Referring to FIG. 2, in accordance with one embodiment, it is desirable to identify computing device 110 by way of a unique identifier (unique ID) 115 associated with the computing device 110 preferably in correlation with a reference to a cookie also associated with computing device 110 (S210). Without limitation, the unique ID may be a Mac Address or other unique identifier associated with either computing device 110 or software running on computing device 110. Other examples of a unique ID include: Bluetooth ID, Radio-frequency identification (RFID) or the International Mobile Station Equipment Identity of communication chips installed on computing device 110.

Depending on implementation, a cookie may include a set of data that may be used to track the identity and behavior of a consumer as the consumer views content (e.g., by visiting on one or more webpages). The browsing, querying and retrieval of the content may be performed by using a tool (e.g., browser software) installed on computing device 110. A cookie may be stored on computing device 110 when the consumer browses a webpage hosted by remote server 120, for example. The content of the cookie may be updated based on the consumer's browsing activity. A copy of the same cookie (or data that may be used to identify the cookie) may be also stored on a remote server 120 to track the webpages and content viewed.

In accordance with one embodiment, a scheme is implemented to establish a correlation between the unique ID 115 for computing device 110 and a cookie stored on server 120 (and optionally on computing device 110). A direct correlation between the unique ID 115 and the cookie information helps identify the particular computing device 110 and by extension the consumer that uses the device. The identifying information, when provided to remote server 120 or an analytical engine (not shown), may help track the activities of the particular consumer both online and inside a physical store.

As shown in FIG. 1, in one embodiment, computing device 110 is equipped with communication capabilities (e.g., a Wifi chip) to connect to a local network 140 available in a physical retail store, for example. Wifi is used herein as an example and is a communication technology utilized for establishing a wireless communication between a communication device (e.g., computing device 110) and a local communication system (e.g., a Wifi adapter or router) that is connected to one or more servers (e.g., remote server 120). Once a connection is established between computing device 110 and remote server 120, computing device 110 may browse content available on remote servers 120.

It is noteworthy that in other example embodiments, communication technologies (e.g., Bluetooth, WiMax, cellular, etc.) other than the Wifi technology may be utilized. As such, the scope of the claimed subject matter herein should not be construed as limited to the example Wifi setting disclosed here. If the Wifi capability of computing device 110 is turned on when a consumer enters the store with computing device 110, a location tracker 150 may be utilized to capture the device's unique ID 115 and location of computing device 110. Location tracker 150 may be equipment installed in the retail store and configured to track location and moving speed of computing device 110 in the retail store (S220).

In one example scenario, location tracker 150 may capture the unique ID 115 associated with computing device 110 and track the location of computing device 110 in the physical store, when computing device 110 establishes a Wifi connection with the in-store Wifi adaptor or router, for example. The location tracker 150 may be configured to track the location and moving speed of computing device 110 inside the store based on, for example, the device's Wifi signal strength (e.g., received signal strength indicator (RSSI)) or other factors related to the number of frames transmitted by computing device 110 (e.g., the device's relative capture frame count (RCFC)).

The speed and the location of computing device 110 may be periodically reported to server 120 or an analytical engine to monitor the respective consumer's activity within the store. Using this information, in one embodiment, it is possible to collect, without requiring a user login process, information about a unique consumer's preferences and activities based on the consumer's (1) visit to a physical store and (2) browsing activities directed to the corresponding webpages for the same store. A mapping of the physical store to the store's webpages may be instrumented by way of, for example, identifying the products in one or more physical zones in the store and associating those zones to one or more webpages on the store's website where the products may be purchased or viewed.

In accordance with one embodiment, once the consumer enters the physical store, the consumer is uniquely identified by way of the unique identifier 115 associated with the consumer's computing device 110 (e.g., presuming that the user's computing device 110 connects to the Wifi network in the store). The location, path and speed of the consumer may be accordingly tracked by way of the location tracker 150, which is configured to identify the consumer's computing device 110 position and moving speed through different zones in the store. The average speed of the consumer may be determined (S230), for example, as he enters the store and passes through areas without any products to determine with some accuracy how fast the consumer moves through store isles that he is not interested in. In the above example, once the average speed of a consumer is determined, then a threshold speed may be determined (S240), for example, at or near the average speed.

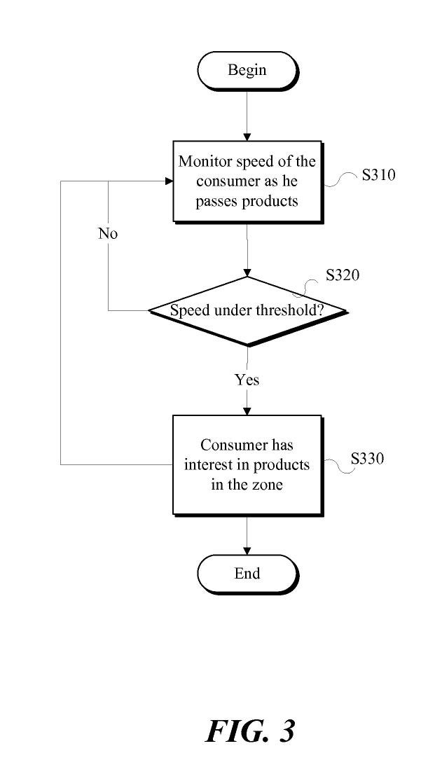

Referring to FIG. 3, the speed of the consumer is monitored as he passes the products in one or more zones (S310). If the consumer's speed is slower than the threshold speed (S320), then it is assumed that the consumer is browsing the items in the isles or zones in which he is moving through with some level of interest (S330). As such, the consumer's level of interest in certain isles may be determined based on changes in his detected speed, or when he is stopped, for example. A complete stop may be identified as high interest, for example, where moving at a speed close but under the threshold speed may be identified as low interest, and moving at a speed above the threshold speed may be identified as no interest.

Based on the information gathered and optionally time stamping of the information, it may be also determined how long the consumer remains in a particular zone. That is, the location of a unique consumer in different zones in the physical store may be time stamped. This information may be provided to an analytical engine or server 120 and may be stored in association with the unique ID 115 and by extension a particular consumer. If the consumer registers online and creates a user account with a retailer, additional information about the consumer's personal profile may be also stored. In the event that the consumer does not register, the consumer may still be uniquely tracked based on unique ID 115, but in an anonymous manner.

If the consumer's computing device 110 with the unique ID 115 is capable of browsing the web, and optionally if an identifying cookie is stored on the computing device 110 in association with the unique ID 115, then at the time of browsing, the consumer may be identified with some level of particularity based on the correlation between the cookie and the user ID 115. If so, then the browsing behavior of the consumer may be traced as uniquely applicable to that consumer. The cookie may be stored, depending on implementation, by way of an application that runs on the computing device 110 and captures the unique ID 115, for example. The application may be configured to report the unique ID 115 in association with the cookie to be stored in a database in remote server 120, for example.

Based on the patterns recognized about in-store and online activities of the consumer, a profile for the unique consumer may be developed, even if the actual identity of the consumer remains anonymous. The above method provides helpful information about shopping patterns of uniquely identified consumers and their environment and allows for the possibility to merge collected in-store browsing data with web browsing data to generate a collective report that provides an understanding of the consumer's behavior across the two channels (i.e., virtual v. physical). Such information may be used for the purposes of research, consumer advocacy, promotional concerns, sales evaluation, cross-channel advertising, consumer profiling, etc.

In the following, example implementations of one or more specific embodiments are suggested to provide a better understanding of the concepts and ideas disclosed above. It is noteworthy, however, that other implementations or embodiments are also possible and that the scope of the claimed subject matter should not be construed as limited to the example implementations or embodiments provided below.

In one embodiment, the data collected based on in-store activities of the consumer is mapped to the data collected based on the consumer's web browsing activities where identified in-store zones are mapped to corresponding webpages. The mapping scheme may assume the following:
1) Location tracker 150 is configured to track consumers as the consumers move throughout various physical zones in the retail store and provides tools to define the zones.
2) A website with webpages to which the physical zones may be mapped.
3) Tool for mapping between the physical store zones and website pages. Depending on implementation, a webpage may map to one or more physical store zones, and a store zone may map to one or more webpages.
4) Method for uniquely identifying customers across the web and store channels.
5) Tool for defining the meaning of web key performance indicators (KPIs) in a physical setting.

In one embodiment, the following criteria may be used to define how a consumer's activity in a physical store zone would define a KPI that may be mapped to a relevant web action:
A) A web click to select content=time spent by a consumer in a zone is greater than a first threshold X, where X is either a static number or relative to a factor (e.g., Y % greater than average time in all zones).
B) Conversion=consumer leaves the store after going through a cash register or checkout lane zone, or makes a purchase on the web while inside the store.
C) Bounce=consumer leaves the store without going through the cash register or checkout lane zone.
D) New Visitor=if a detected unique ID for a computing device has not been previously detected by location tracker 150.
E) Click Path=List of physical zones in which the computing device dwelled (e.g., time spent by the consumer in the zone was greater than a first threshold) and the order in which the dwelled physical zones were traversed.

In one embodiment, consumer browsing patterns on the web are collected via tools such as Google Analytics or Coremetrics, which indicate on which webpages unique consumers land, how long they spend on each webpage, and where they go next. The location tracker 150 tracks the movement on the unique consumers as they move from zone to zone in the physical store and reports the results to a store pattern database, which includes for a zone visited by the customer, at least, one or more of the following attributes:
Unique ID;
Zone ID;
Date/Time Zone Entered;
Date/Time Zone Exited; or
Previous Zone.

The above information may be used to determine that a unique customer dwelled in a given zone. An example algorithm is provided below that may be utilized to determine the zones in which a consumer dwelled in while in the physical store:

Definitions:
SA=Customer A's average speed as he walks through non-product areas of the store (entrance way for example)
A=unique ID of customer
DwellArray[zone, dwellCount]=array of zones transversed and time spent in each

Method of Tracking Customer Movement:
i=0
DwellCounter=0
Zone=x
While (A is in ZoneX)
   DwellCounter++
DwellArray[i]=dwellCounter
DwellCounter=0
i++

Method for Identifying Dwell Zones:
Loop over dwellArray
   For each entry if dwellCount<=1.x % of SA
      then mark zone as passed through (no dwell)
   Otherwise mark the zone as dwelled by the customer

In one embodiment, the speed of movement of a consumer in the physical zones may be compared to other consumers in the store and to the consumer's speed of movement and dwell patterns in previous visits to the store to build a more accurate profile for the consumer. In the above example implementation, physical zones marked as dwelled may be considered as the equivalent to clicks on a webpage and may be stored as a click path. If a consumer is detected as going through an identified cash register or checkout zone at a certain time according to a time-stamp, for example, in-store information about a sale at the particular time and particular checkout zone may be attributed to the particular consumer. An analytical engine may be used to merge the collected in-store and web data based on the defined mappings.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

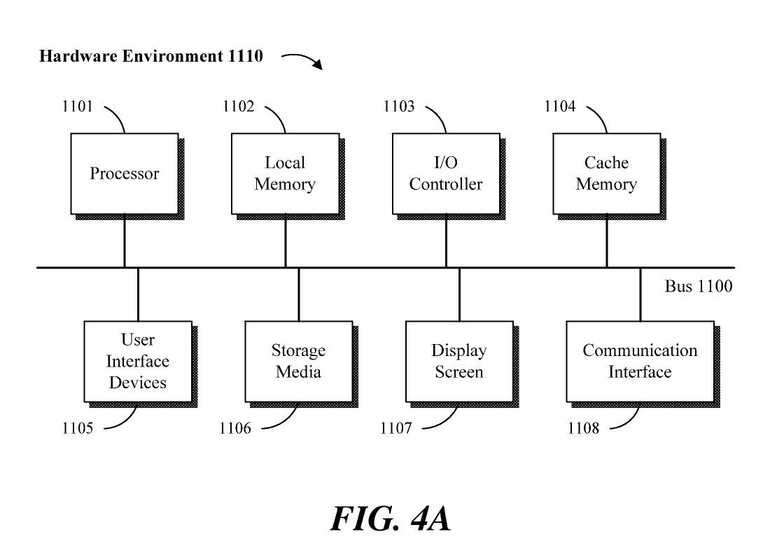

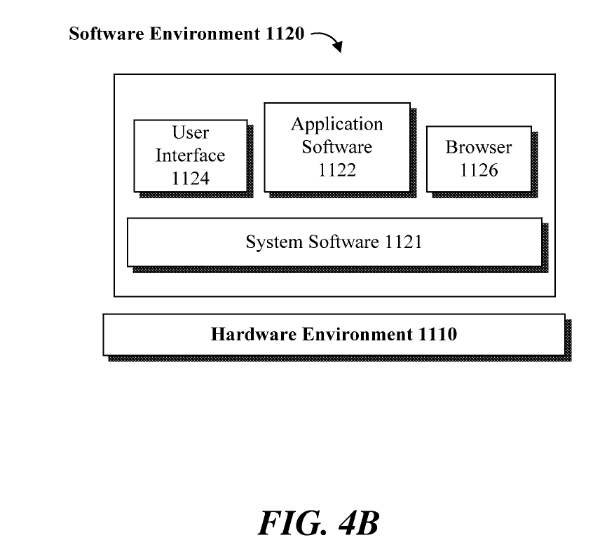

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-Ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method of cross-referencing a consumer's shopping activities in a physical venue to the consumer's online activities, the method comprising:
uniquely identifying a consumer based on a unique ID associated with the consumer's mobile communication device;
monitoring speed and location of the consumer in one or more zones in a physical venue by detecting and processing communication signals broadcasted by the consumer's mobile communication device;
determining level of interest of the consumer in one or more products positioned in the one or more zones in the physical venue based on speed with which the consumer moves through the one or more zones; and
equating a first level of interest in a first product in the physical venue to a page view on a webpage that promotes the first product or group of products.

2. The method of claim 1, wherein the unique ID comprises a unique ID associated with the mobile communication device's Mac Address, Bluetooth ID, Radio-frequency identification (RFID) or the International Mobile Station Equipment Identity of communication chips installed on the mobile communication device.

3. The method of claim 1, wherein a high level of interest is detected in a product or a family of products in a zone, if speed of the consumer while travelling through the zone falls below a first threshold.

4. The method of claim 1, wherein a low level of interest is detected in a product or family of products in a zone, if speed of the consumer while travelling through the zone is above of first threshold.

5. The method of claim 3, wherein the first threshold is calculated based on detected speed of the consumer in a zone with no displayed products.

6. The method of claim 5, wherein the detected speed of the consumer is based on the average speed of the consumer in the zone with no displayed products.

7. The method of claim 3, wherein the first threshold is calculated based on detected speed of at least one consumer in one or more zones.

8. The method of claim 1, wherein a conversion zone is associated with areas of the physical venue in which cash registers are located, and wherein if upon exit the consumer travels through the conversion zone then it is assumed that the consumer purchased an item.

9. The method of claim 1, wherein a conversion zone is associated with areas of the physical venue in which cash registers are located, and wherein if upon exit the consumer does not travel through the conversion zone then it is assumed that the consumer did not purchased an item.

10. The method of claim 1, wherein an online purchase is detected, in response to determining that the uniquely identified consumer used the mobile communication device to order an item.

11. The method of claim 9, wherein the zone in which the consumer was travelling when the consumer made the online purchase is recorded.

12. The method of claim 1, wherein information gathered from monitoring paths travelled by the consumer in the physical venue is used to cross-reference the consumer's activities online.

13. The method of claim 1 wherein information about high levels of interest in one or more products or a family of products in one or more zones is detected, if speed of the consumer while travelling through the zones falls below a first threshold, and wherein a list of zones in which the high levels of interests were detected in order of detection is generated in form of a click path that cross-references a path on one or more webpages.

14. The method of claim 1, wherein a mapping is instrumented by way of which products in one or more zones in the physical venue are associated with products in one or more webpages on a website.

15. The method of claim 1 wherein a consumer visiting the physical venue for the first time is detected, if a detected unique ID for a mobile computing device used by the consumer has not been previously detected.

16. A system for cross-referencing a consumer's shopping activities in a physical venue to the consumer's online activities, the system comprising:
a logic unit for uniquely identifying a consumer based on a unique ID associated with the consumer's mobile communication device;
a logic unit for monitoring speed and location of the consumer in one or more zones in a physical venue by detecting and processing communication signals broadcasted by the consumer's mobile communication device;
a logic unit for determining level of interest of the consumer in one or more products positioned in the one or more zones in the physical venue based on speed with which the consumer moves through the one or more zones; and
a logic unit for equating a first level of interest in a first product in the physical venue to a page view on a webpage that promotes the first product or group of products.

17. The system of claim 16, wherein the unique ID comprises a unique ID associated with the mobile communication device's Mac Address, Bluetooth ID, Radio-frequency identification (RFID) or the International Mobile Station Equipment Identity of communication chips installed on the mobile communication device.

18. The system of claim 16, wherein a high level of interest is detected in a product or a family of products in a zone, if speed of the consumer while travelling through the zone falls below a first threshold.

19. A computer program product comprising a computer readable storage medium having a computer readable program, wherein the computer readable program when executed on a computer causes the computer to:
uniquely identify a consumer based on a unique ID associated with the consumer's mobile communication device;
monitor speed and location of the consumer in one or more zones in a physical venue by detecting and processing communication signals broadcasted by the consumer's mobile communication device;
determine level of interest of the consumer in one or more products positioned in the one or more zones in the physical venue based on speed with which the consumer moves through the one or more zones; and
equate a first level of interest in a first product in the physical venue to a page view on a webpage that promotes the first product or group of products.

20. The computer program product of claim 19, wherein the unique ID comprises a unique ID associated with the mobile communication device's Mac Address, Bluetooth ID, Radio-frequency identification (RFID) or the International Mobile Station Equipment Identity of communication chips installed on the mobile communication device.
